(19) United States
(12) Patent Application Publication
(10) Pub. No.: US 2003/0053371 A1
(43) Pub. Date: Mar. 20, 2003

(54) Magnetic stirring apparatus and an agitating device

(76) Inventor: Reto Schoeb, Volketswil (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/912,695

(22) Filed: Jul. 23, 2001

(30) Foreign Application Priority Data
Sep. 13, 2000 (EP) 00810822.7

(51) Int. Cl. B01F 13/08

(52) U.S. Cl. 366/273; 435/302.1

(57) ABSTRACT

The magnetic stirring apparatus (1p ) comprises an agitator (1a), at least one permanent magnet (1d, 1e) and a float body (1f), which are connected to one another.

The invention relates to a magnetic stirring apparatus in accordance with the preamble to claim 1. The invention further relates to an agitating device in accordance with the preamble to claim 10.

Bar magnets are known which are used to stir liquids by adding the bar magnet to a container containing liquid and setting the container on a rotating magnetic field so that the bar magnet is set into rotation.

It is disadvantageous with such bar magnets that they rest on the bottom of the container and thus only generate a limited stirring effect. The frictional forces occurring between the bar magnet and the bottom can moreover effect abrasion or destroy parts, such as living cells, contained in the liquid.

It is the object of the present invention to propose a more advantageous magnetic stirring apparatus and a more advantageous agitating device.

This object is satisfied by a magnetic stirring apparatus having the features of claim 1. The dependent claims 2 to 9 relate to further advantageous embodiments of the magnetic stirring apparatuses. The object is further satisfied by an agitating device having the features of claim 10. The dependent claims 11 to 14 relate to further advantageously designed embodiments of the agitating devices.

The object is satisfied in particular by a magnetic stirring apparatus comprising an agitator, a permanent magnet and a float body, which are connected to one another.

An important aspect of the invention comprises the magnetic stirring apparatus being formed such that the agitator is arranged spaced from the bottom of the container so that the agitator no longer slidingly rotates on the bottom during stirring.

In a preferred embodiment, the magnetic stirring apparatus is formed in an elongate. essentially bar-like manner, with the agitator being arranged in the region of the first end section and a float body being arranged in the region of the second end section. In a particularly advantageous embodiment, the end of the first end section is formed as a tip. This magnetic stirring apparatus is put into a container containing liquid, with the magnetic stirring apparatus being held in an essentially vertically extending orientation and being stabilised against tilting by the buoyancy forces acting on the float body. The float body thus effects a hydrodynamic stabilisation of the magnetic stirring apparatus against tilting and thus stabilises the magnetic stirring apparatus with respect to two degrees of freedom.

A device is arranged beneath the bottom of the container which allows a magnetic rotating field to be generated. This device is formed in a preferred embodiment as a magnetic coupling comprising a rotating permanent magnet. This permanent magnet acts on the permanent magnets arranged in the agitator. The position of the agitator and thus the position of the magnetic stirring apparatus is determined with respect to three degrees of freedom, namely in the x and y directions and with respect to the rotation, by the magnetic coupling formed in this way. This is only stabilised with respect to a downward movement in the vertical direction, that is in the direction of extension of the magnetic stirring apparatus, by the tip which forms a toe bearing together with the bottom of the container. Together with the downward acting magnetic force of the magnetic coupling, the vertical degree of freedom (z direction) is also stabilised.

The magnetic stirring apparatus is thus stabilised with respect to 6 degrees of freedom. The known bar magnet initially mentioned is only stabilised with respect to 4 degrees of freedom, namely in the x and y directions, with respect to rotation, since it is on the bottom of the container, and with respect to a downward movement. The magnetic stirring apparatus in accordance with the invention thus has the advantage that it is stabilised with respect to more degrees of freedom, which allows the agitator to be arranged spaced from the bottom of the container.

In a further advantageous embodiment, the magnetic stirring apparatus is arranged in a floating manner in the liquid of the container, with the magnetic stirring apparatus being drivable via a magnetic field arranged outside the container. The rotating magnetic field required for the drive can be generated with the aid of electromagnetic coils or with pivoted magnets, in particular with pivoted permanent magnets which form a magnetic coupling with the magnetic stirring apparatus. Moreover, the position of the magnetic stirring apparatus is influenced in an advantageous embodiment using the permanent magnets by these permanent magnets forming part of a passive magnetic bearing. The one part of the passive magnetic bearing is arranged outside the container and exerts a stabilising effect on the position of the magnetic stirring apparatus located inside the container. The object is further satisfied with an agitator comprising a magnetic stirring apparatus having one or more permanent magnets and a float body and comprising a magnetic drive device, with the drive device and the permanent magnets of the magnetic stirring apparatus being arranged and formed in a mutually matched manner such that they form a magnetic coupling.

The invention is described in the following by way of several embodiments. There are shown:

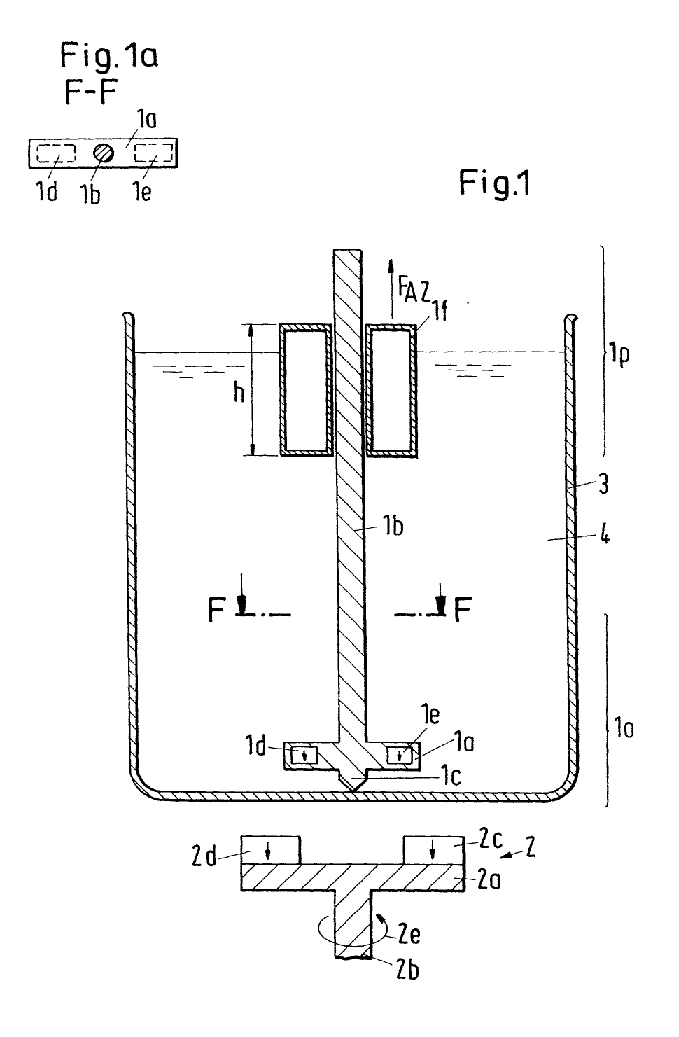

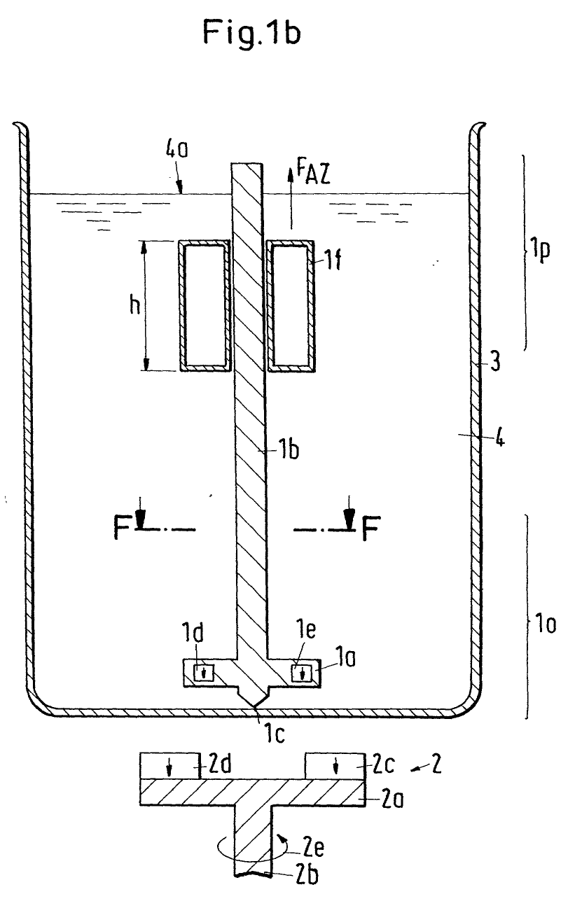

FIG. 1 a longitudinal section through an agitator having a magnetic stirring apparatus resting in the container;

FIG. 1a a detailed view of the agitator;

Fig. 1b a magnetic stirring apparatus having a completely submerged float body;

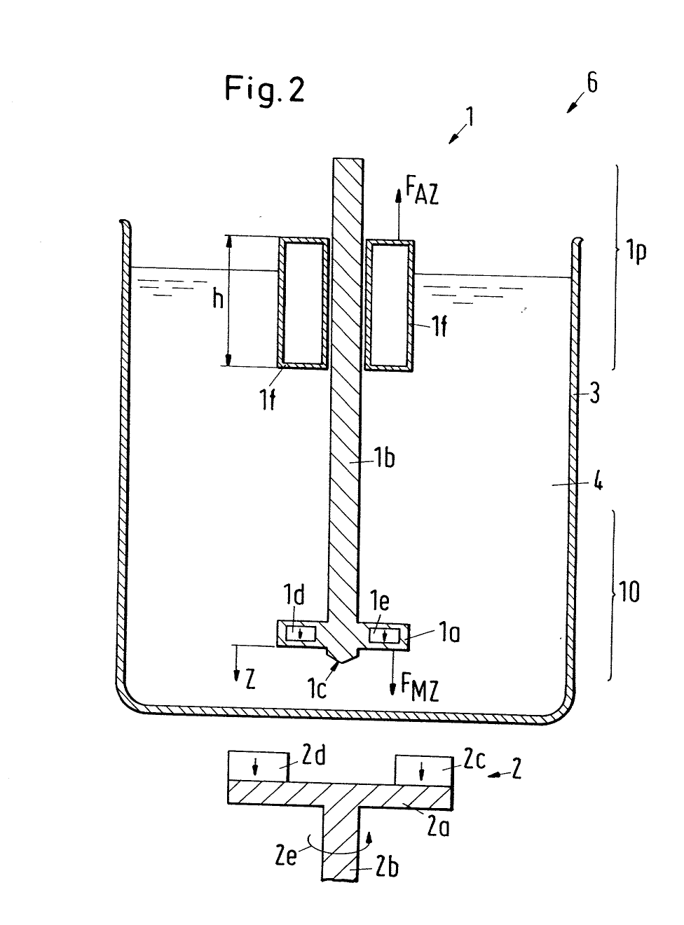

FIG. 2 a longitudinal section through a first agitating device having a magnetic stirring apparatus;

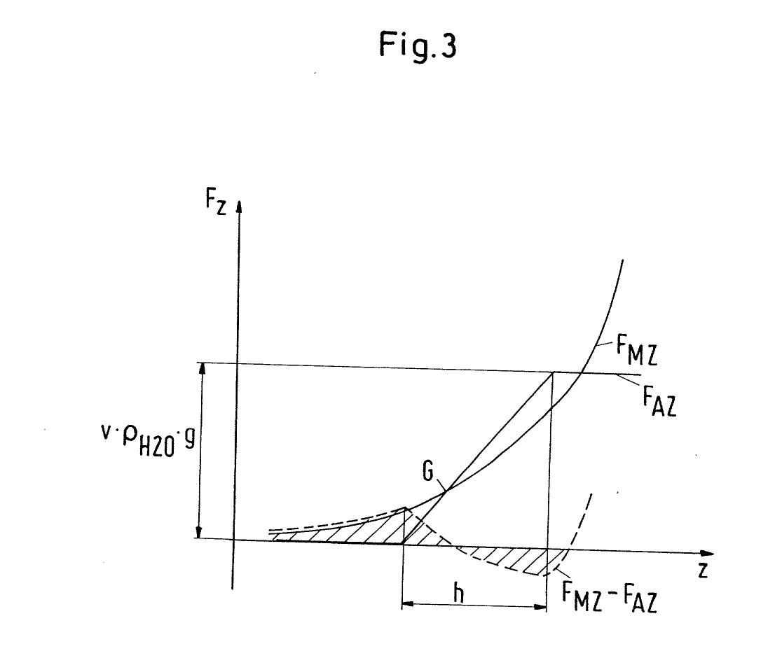

FIG. 3 a path-force diagram of the magnetic stirring apparatus;

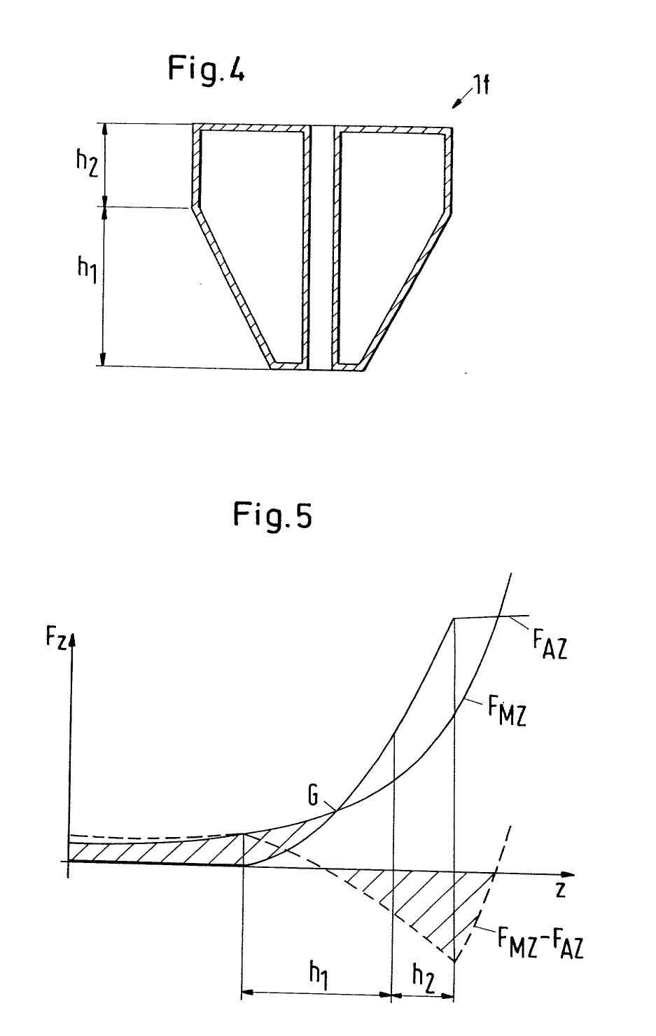

FIG. 4 a cross-section through a float body;

FIG. 5 a path-force diagram of a further magnetic stirring apparatus;

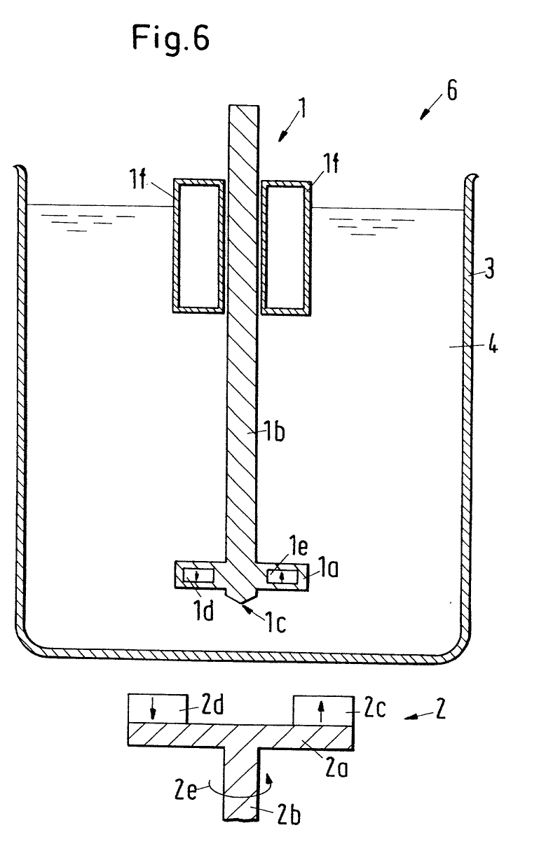

FIG. 6 a longitudinal section through a further agitating device having a magnetic stirring apparatus;

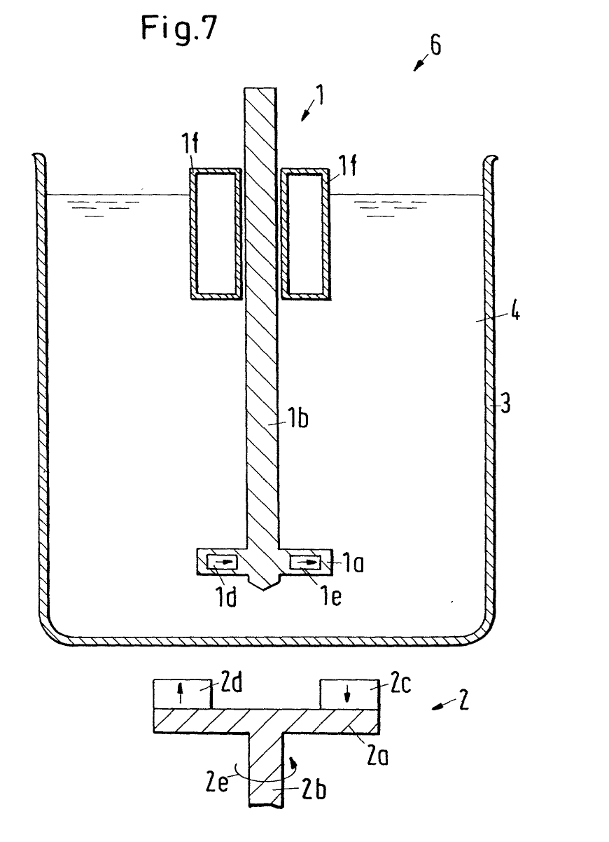

FIG. 7 a longitudinal section through a further agitating device having a magnetic stirring apparatus;

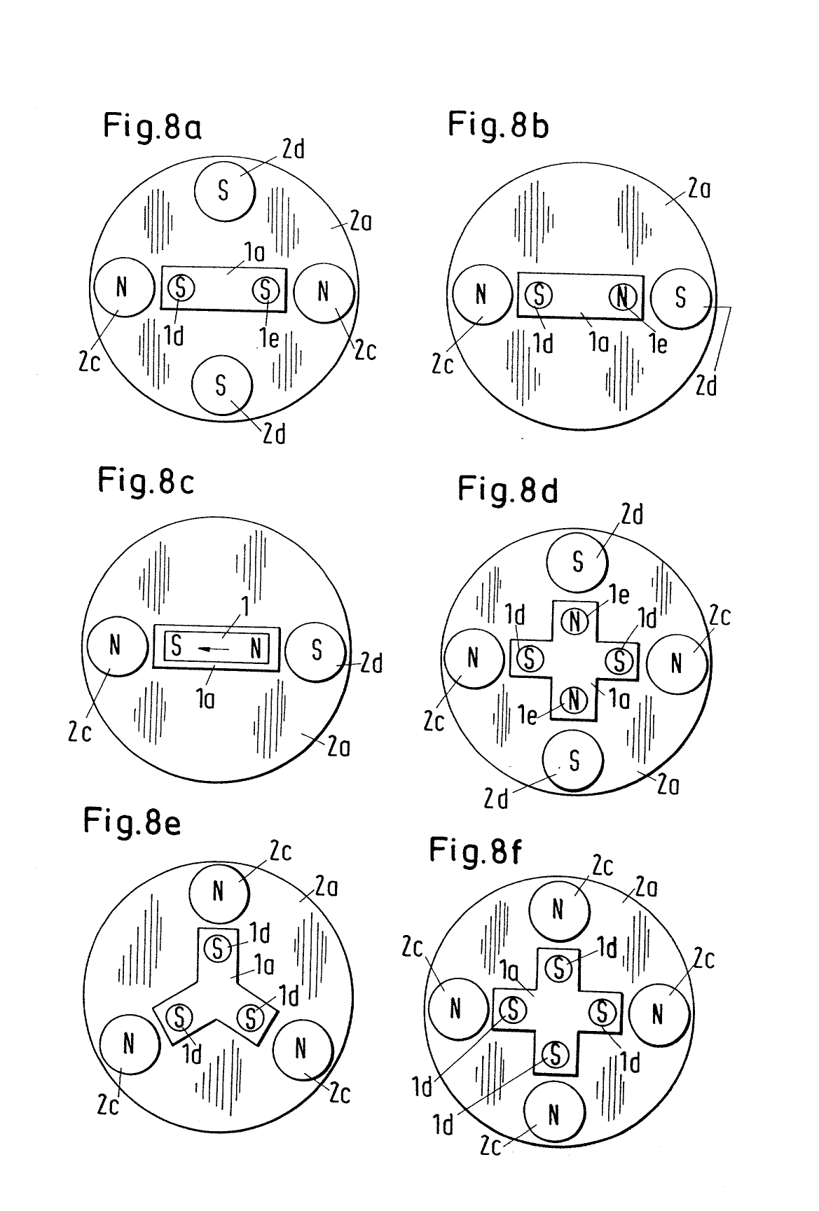

FIGS. 8a-8f different arrangements of the permanent magnets of the magnetic stirring apparatus and the agitating device;

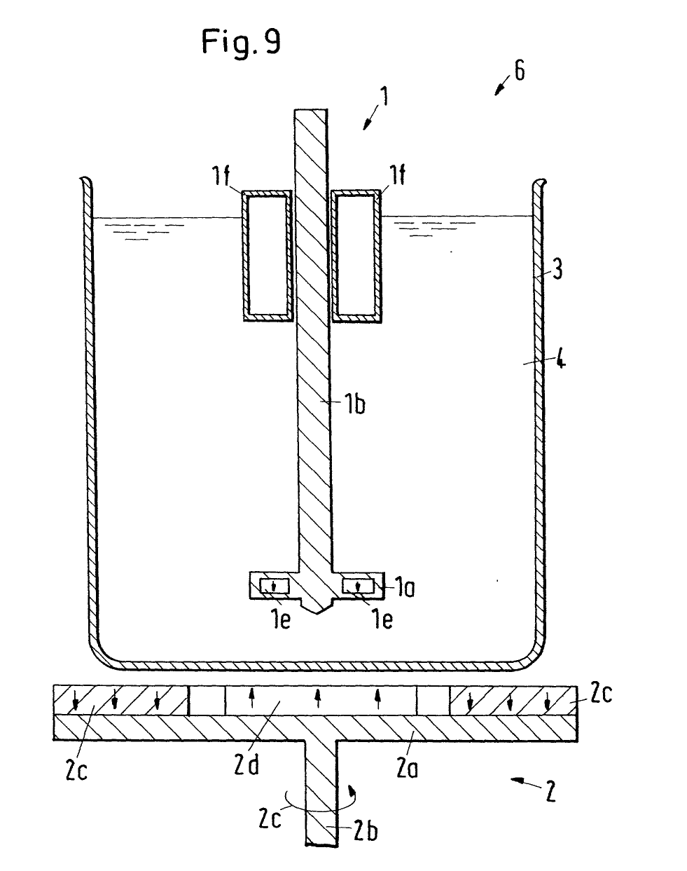

FIG. 9 a longitudinal section through a further agitating device having a magnetic stirring apparatus;

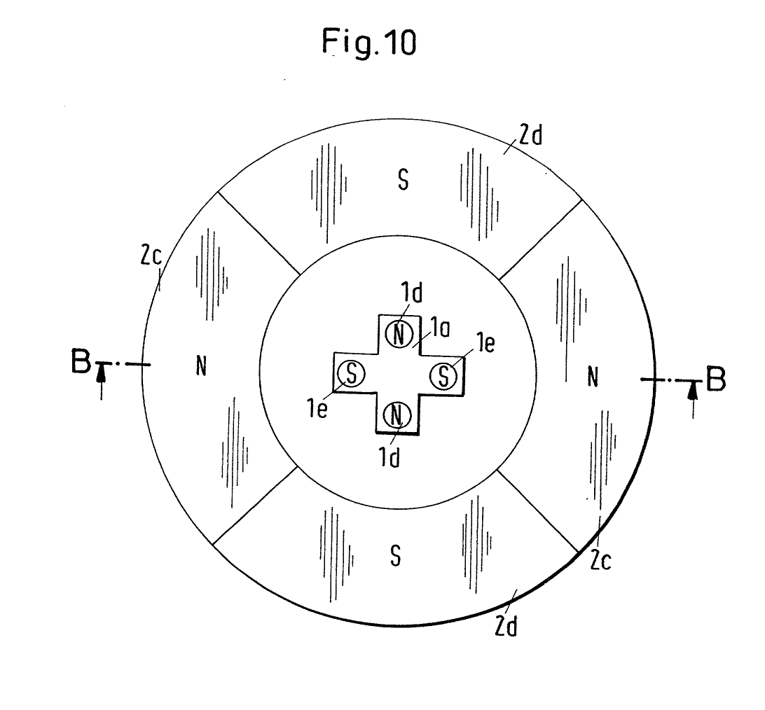

FIG. 10 a plan view of the drive device shown in FIG. 1;

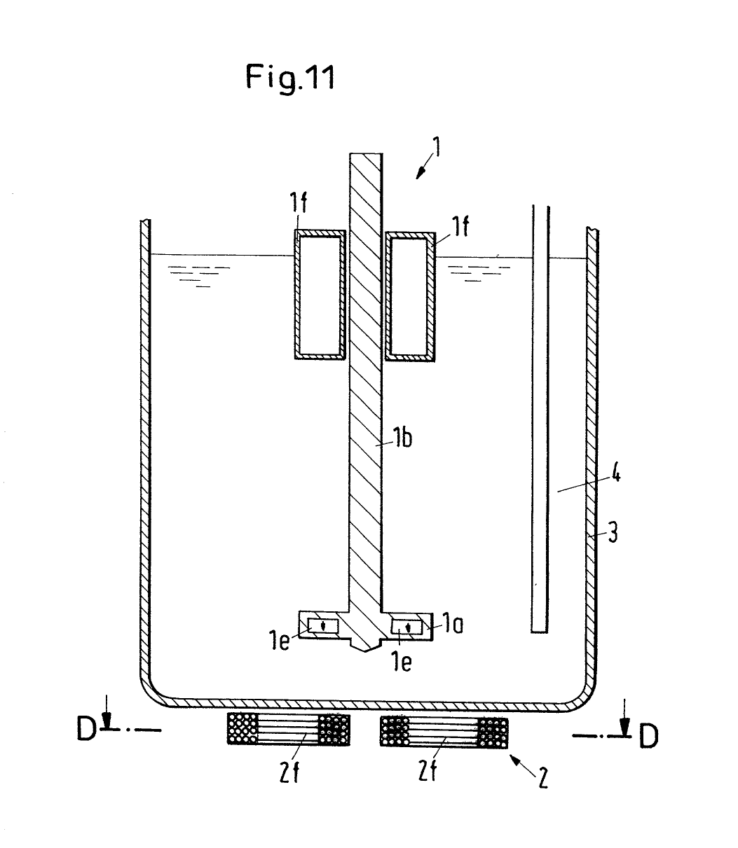

FIG. 11 a longitudinal section through an agitating device having a magnetic stirring apparatus and provided with electromagnetic coils;

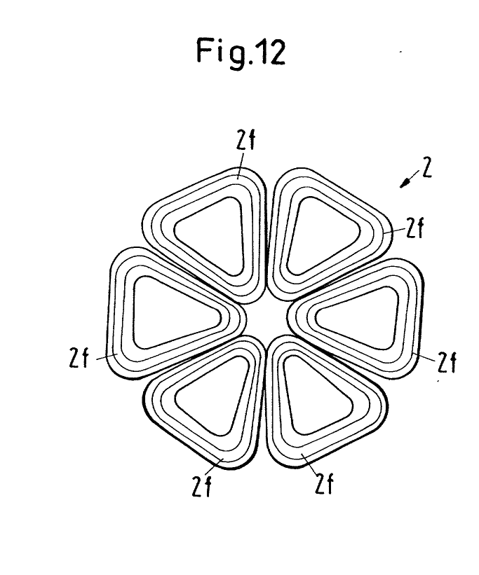

FIG. 12 a plan view of the electromagnetic coils shown in FIG. 1 1;

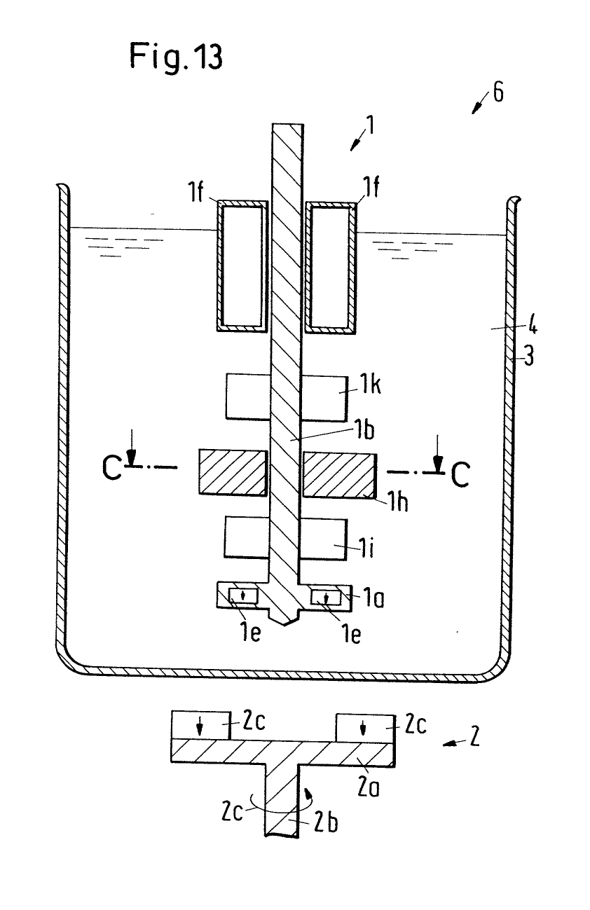

FIG. 13 a longitudinal section through a further agitating device having a magnetic stirring apparatus;

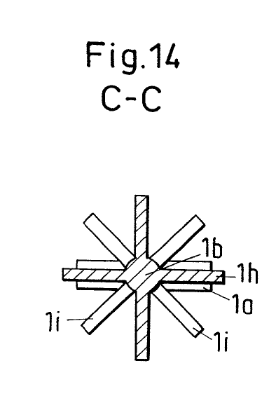

FIG. 14 a cross-section through a vane arranged at the magnetic stirring apparatus;

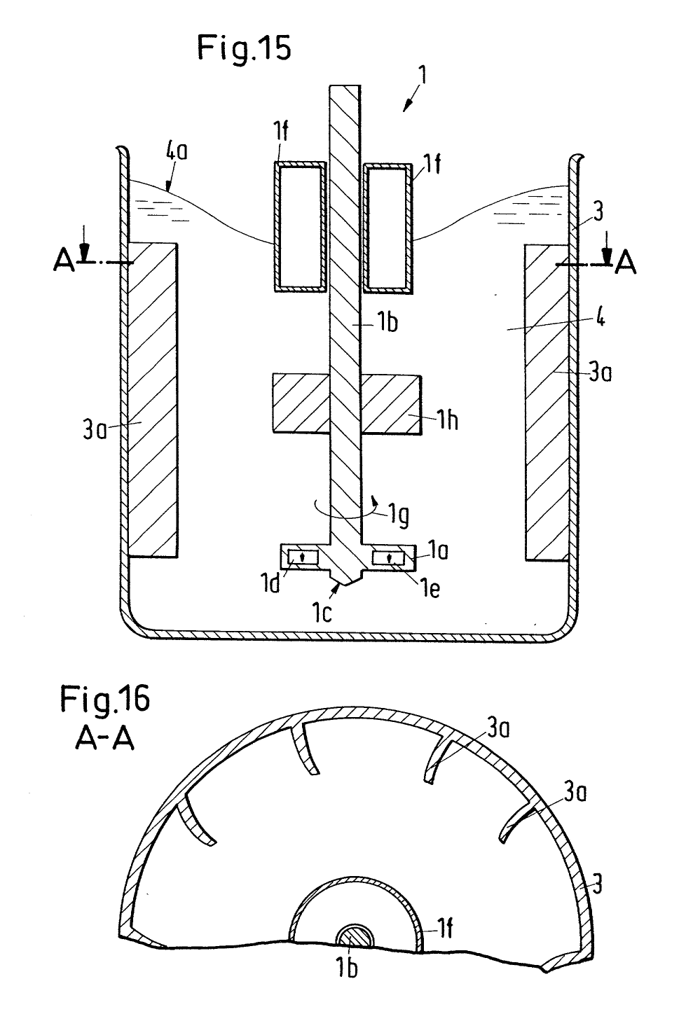

FIG. 15 a longitudinal section through a further agitating device having a magnetic stirring apparatus;

FIG. 16 a cross-section through the container in accordance with FIG. 15, along the intersection line A-A;

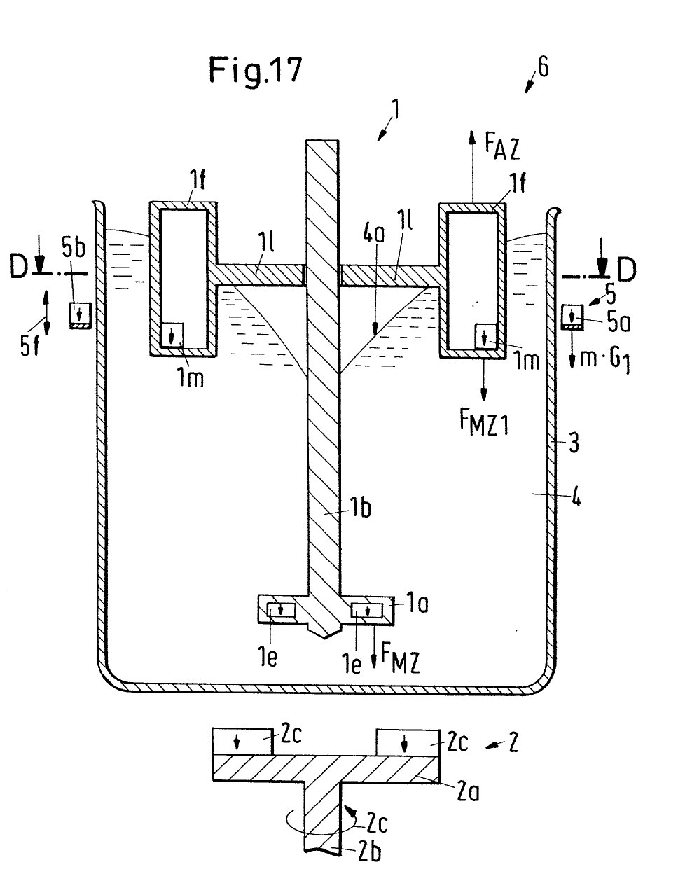

FIG. 17 a longitudinal section through a further agitating device having a magnetic stirring apparatus;

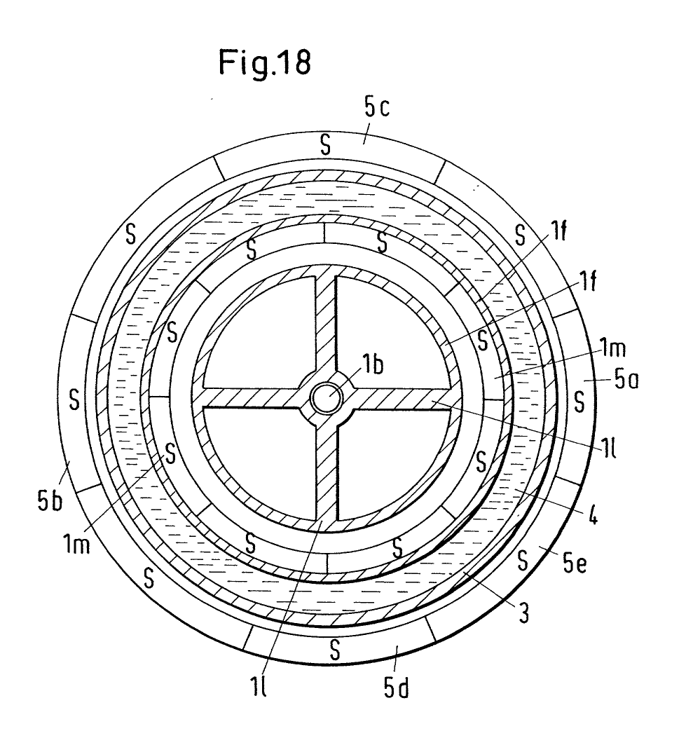

FIG. 18 a cross-section through the agitating device shown in FIG. 17, along the intersection line D-D;

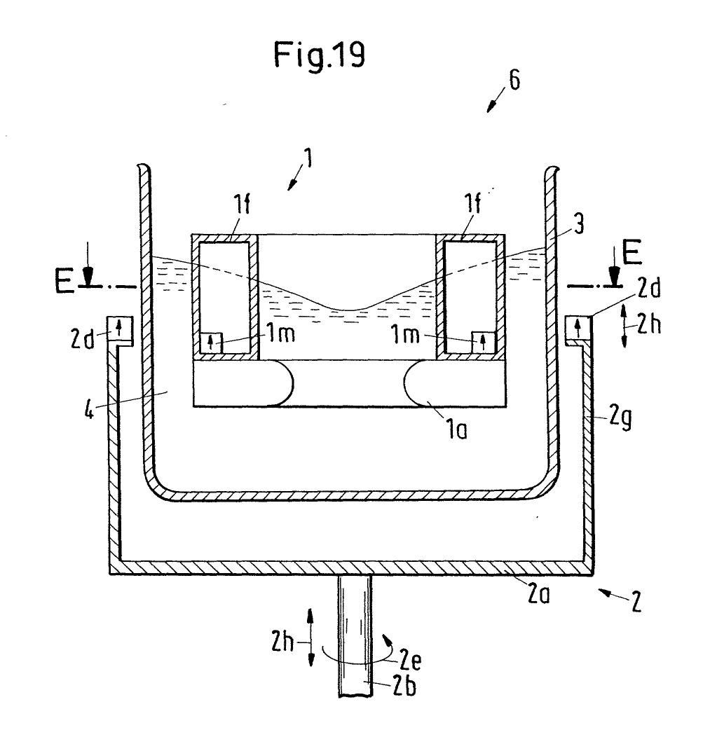

FIG. 19 a longitudinal section through a further agitating device having a magnetic stirring apparatus;

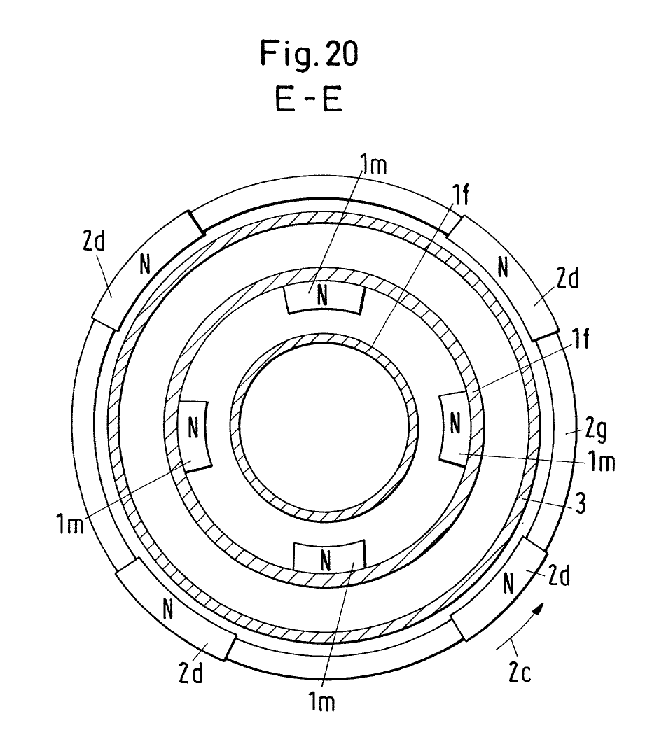

FIG. 20 a cross-section through the agitating device shown in FIG. 19, along the intersection line E-E;

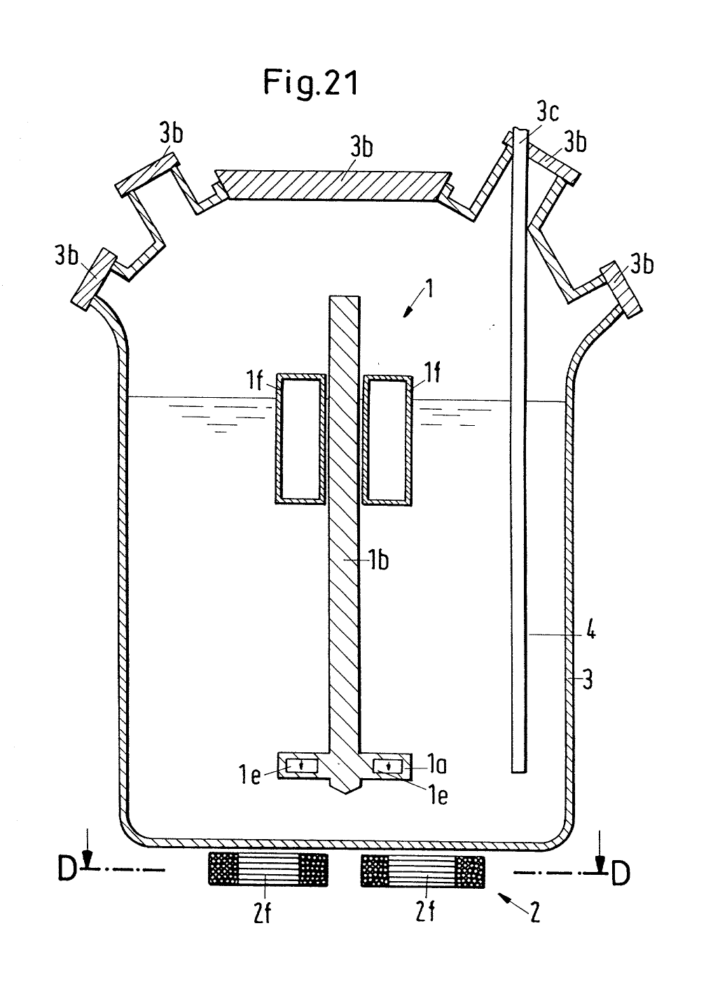

FIG. 21 an agitating device in combination with a bio-reactor.

FIG. 1 shows, in a longitudinal section, a magnetic stirring apparatus 1 comprising an agitator 1a, a bar 1b and a float body 1f, which are connected to one another. Two permanent magnets 1d, 1e are arranged symmetrically with respect to the bar 1b inside the agitator 1a, as shown in Fig. 1a in the section F-F. The bar 1b opens downwardly into a tip 1c, which forms a toe bearing together with the bottom of the container 3. The agitator 1a is arranged slightly spaced from the tip 1c in the first end section 1o of the bar 1b so that the agitator does not touch the bottom of the container 3. The float body 1f is arranged in the second end section 1p. The float body 1f is displaceable in the direction of extension of the bar 1b and can be fixedly connected to the bar 1b by a fastening means (not shown) such as a screw. The magnetic stirring apparatus 1 is held in a substantially vertical position by the liquid 4 located inside the container 3 and the buoyancy force FAZ thus effected on the float body 1f. The float body if thus stabilises the magnetic stirring apparatus 1 hydrostatically against tilting so that the position of the magnetic stirring apparatus is thereby hydrostatically stabilised with respect to two degrees of freedom.

A drive device 2 is arranged beneath the container 3. The drive device 2 comprises a plate 2a and an axle 2b pivoted in the direction of rotation 2e, with two permanent magnets 2c, 2d being fixedly connected to the plate 2a. The permanent magnets 1d, 1e of the magnetic stirring apparatus 1 and the permanent magnets 2c, 2d of the drive apparatus 2 are arranged and formed in a mutually matched manner such that they jointly form a magnetic coupling in order to drive the magnetic stirring apparatus 1 in the direction of rotation 2e. This magnetic coupling stabilises the magnetic stirring apparatus 1 with respect to the radial position in the x and y directions and in the direction of rotation so that the magnetic coupling stabilises the magnetic stirring apparatus 1 with respect to three degrees of freedom.

The magnetic stirring apparatus 1 rises on the toe bearing 1c such that the magnetic stirring apparatus 1 is stabilised with respect to a downward movement so that the magnetic stirring apparatus 1 is stabilised with respect to one degree of freedom by the toe bearing and the magnetic force of attraction between the permanent magnets 1d, 1e, 2c, 2d. The position of the magnetic stirring apparatus 1 is thus stabilised with respect to 6 degrees of freedom by the means shown in FIG. 1.

It is a required condition of the hydrostatic stabilisation that the float body 1f is at least partially submerged in the liquid or, as shown in Fig. 1b, is completely submerged. For the toe bearing 1c to rest on the bottom of the container 3, it is necessary for the weight of the magnetic stirring apparatus 1 and the force of attraction effected by the magnetic coupling to be greater than the buoyancy force FAZ effected by the float body.

In distinction to the arrangement shown in FIG. 1, the magnetic stirring apparatus 1 is held in a floating manner in the liquid 4 of the container 3 since the buoyancy force FAZ and the weight of the magnetic stirring apparatus 1 and the magnetic force effected by the magnetic coupling are in a state of equilibrium. For this purpose, the float body 1f should be arranged in the corresponding position along the bar 1b. To meet this condition, the float body if is displaceable on the bar 1b so that the position of the float body if is adjustable in dependence on the liquid level such that the tip 1c of the magnetic stirring apparatus 1 rests on the bottom of the container 3. After the displacement of the float body 1f, this is fixedly connected to the bar 1b, for example by a screw.

This arrangement has the advantage that the magnetic stirring apparatus 1 is held in a floating and contact-free manner in the container 3. The space between the agitator 1a and the bottom of the container 3 is shown by the dimension z. A force FMZ acts downwardly on the magnetic stirring apparatus 1, with said force FMZ being composed of gravity and the magnetic force of attraction effected by the drive device 2.

FIG. 3 shows the path-force diagram of the magnetic stirring apparatus 1 floating in the liquid, with the submersion depth z being shown in the abscissa and the force F in the ordinate. The buoyancy force FAZ effected by the float body 1f located in a liquid such as water increases in a linear manner as a function of the height h as the submersion depth increases and assumes a constant value after the full submersion of the float body 1f. Moreover, the force curve of the force FMZ is shown as a function of the dimension z. A stable state of equilibrium is achieved at the point of intersection G of the two curves FMZ and FAZ. The difference between the force FMZ and the force FAZ is shown as a broken line in FIG. 3. After a malfunction, the system reverts to the stable state of equilibrium G between the two saddle points, limited by the level of the float body. The maximum difference amount between FAZ and FMZ is thus a measure for the robustness of the system. The last degree of freedom of the magnetic stirring device 1, namely the movement vertically upwards, is stabilised by this measure by the buoyancy force together with the magnetic force acting oppositely so that 3 1/2degrees of freedom of the magnetic stirring apparatus 1 are magnetically stabilised and 2½degrees of freedom of the magnetic stirring apparatus 1 are hydrostatically stabilised.

The buoyancy of the float body if as a function of the submersion depth is naturally determined by the shape of the float body 1f. FIG. 4 shows a float body if in a longitudinal section which is formed in a truncated cone-like shape along a height h1 and in a cylinder-like shape along the height h2.

FIG. 5 shows the path-force diagram of a magnetic stirring apparatus 1 having the float body 1f shown in FIG. 4. The force FMZ has the same curve as already shown in FIG. 3. The buoyancy force FAZ generated by the float body 1f shows an increase in force along the section h1 which is bent, in particular square in extension, whereas the float body 1f effects a linear increase in force in the section h2formed in a cylinder-like shape. When the float body 1f is fully submerged, the buoyancy assumes a constant value. The stable point of equilibrium G is reached, in turn, at the intersection of the two curves FAZ and FMZ. The maximum difference between the forces FMZ and FAZ has a higher (negative) sum in comparison with the curve shown in FIG. 3. Since, as explained in the description of FIG. 3, this is a measure for the robustness of the system, this has the advantage in comparison with FIG. 3 that the magnetic stirring apparatus 1 can be held floating-wise in a more stable manner. When the liquid is stirred, the problem actually occurs due to the operative centrifugal force that the level of liquid falls at the centre of the container 3, while increasing at its rim. This has the consequence that the float 1f sinks a little in the container 3, which has the consequence in turn that the distance z is reduced. The magnetic stirring apparatus 1 should also be held in a floating, contact-free manner in the container 3 in this position. To effect a stable behaviour, it is therefore of particular importance for the difference between the forces FMZ and FAZ to have a constant course over a fairly long section.

In distinction to the agitating device 6 shown in FIG. 2, the permanent magnets 1e, 2d are arranged poled in the opposite direction in the embodiment in accordance with FIG. 6.

In distinction to the agitating device 6 shown in FIG. 2, the permanent magnets 1d, 1e are arranged poled in the horizontal direction, whereas the permanent magnets 2c, 2d of the drive device 2 are arranged polarised in an opposite manner and in a vertical direction in the embodiment in accordance with FIG. 7.

The permanent magnets 1d, 1e of the agitator 1a and the permanent magnets 2, 2d of the drive device 2 could be arranged in the most varied ways in order to jointly form a magnetic coupling. Several examples of such arrangements are shown in the FIGS. 8a to 8f. In the plan view of the plate 2a of the drive device 2 shown in FIG. 8a, the four permanent magnets 2c, 2d arranged spread in the peripheral direction are shown, with the permanent magnets 2c and 2d being oppositely poled. FIG. 8b shows an arrangement with only two permanent magnets 2c, 2d. The agitator 1a in FIG. 8c has a single bar magnet 1d The agitator 1a in FIG. 8d has a cruciform shape, with a permanent magnet 1d, 1e being arranged at each arm of the cross. The agitator 1a in FIG. 8e has a star shape, with a permanent magnet 1d being arranged at each arm. Three permanent magnets 2c are also arranged on the plate 2a. The agitator 1a in FIG. 8f is formed as in FIG. 8d as a cross, with the poles of the permanent magnets being aligned in a different orientation in distinction to the embodiment in accordance with FIG. 8d. Examples of further arrangements of the permanent magnets are disclosed, for example, in the article “Permanent Magnet Bearings and Couplings, J.P. Yonnet, IEEE Transactions on magnetics, Vol. Mag-17, No. 1, January 1981”.

In distinction to the agitating device 6 shown in FIG. 2, the plate 2a of the drive device 2 in accordance with FIG. 9 has a relatively large diameter, with the permanent magnets 2c, 2d being formed in a circular annular segment shape, as shown in the plan view in accordance with FIG. 10. The agitator 1a is formed in cruciform shape, as shown in FIG. 10. One advantage of the arrangement shown in FIG. 9 can be seen in that the magnetic field effected by the drive device 2 only shows a small change in the vertical direction so that a change in position of the magnetic stirring apparatus 1 in a vertical direction towards the magnetic coupling formed by the permanent magnets 2c, 2d, 1d, 1e exerts only a slight influence on the coupling behaviour.

In distinction to the agitating device 6 shown in FIG. 2, in the embodiment shown in FIG. 11, the drive device 2 is formed as a plurality of core bodies 2f which, as can be seen from the section along the line D-D shown in FIG. 12, are arranged at regular spacings in the peripheral direction in order to generate an electromagnetic rotating field by a corresponding selection. These coils have several advantages. Unlike permanent magnets, whose force of attraction becomes greater, the nearer the agitator is, a constant magnetic field can be generated with the coils so that the force of attraction does not increase as the distance to the agitator decreases. Moreover, the magnetic field strength can be regulated via the current of the coils. This exerts a stabilising influence on the position of the magnetic stirring apparatus.

In distinction to the agitating device 6 shown in FIG. 2, the magnetic stirring apparatus 1 in the embodiment shown in FIG. 13 has three vanes or blades 1h, 1i, 1k arranged spaced in a vertical direction. This allows the rotational forces of the magnetic stirring apparatus 1 to be transmitted in an even better way to the liquid 4. The section along the line C-C shown in FIG. 14 shows the vane 1h with a cruciform design in section. Moreover, the cruciform vane arranged beneath it and the agitator arranged at the very bottom are shown.

In distinction to the agitating device 6 shown in FIG. 2, the magnetic stirring apparatus 1 shown in FIG. 15 has an additional vane 1h which is fixedly connected to the bar 1b. This vane 1h serves the better transmission of the rotational forces acting on the magnetic stirring apparatus to the liquid 4. The stirring of the liquid 4 effects an increase of the liquid level 4a at the rim of the container 3, whereas the liquid level 4a falls at the centre, which has the consequence that the magnetic stirring apparatus 1 sinks. The change in the liquid level 4a or the rotation speed of the liquid can be reduced in the container 3 by a plurality of radially inwardly projecting rotation brakes 3a being arranged at the inside wall of the container 3, as shown in FIG. 16 along the section A-A.

In distinction to the agitating device 6 shown in FIG. 2, the magnetic stirring apparatus 1 shown in FIG. 17 has a float 1f with an annular design which is connected to the bar 1b via a connecting means 11. The arrangement and design of the float body 1f is selected such that the liquid level 4a changing during stirring does not have any effect, or only a slight effect, on the level of the magnetic stirring device 1. The liquid shows the surface behaviour designated by 4a due to the stirring of the liquid.

The magnetic stirring apparatus 1 has a relatively great mass and is therefore possibly difficult to hold in a radial direction by the drive device 2. The float 1f is therefore advantageously stabilised with an additional device. For this purpose, permanent magnets 1m are arranged in the float body 1f which extend in the peripheral direction. Moreover, an adjustment device 5 movable in the direction of displacement 5f is arranged outside the container 3 and has permanent magnets 5a, 5b arranged spread in the peripheral direction. The permanent magnets 5a, 5b are arranged with respect to the permanent magnets 1m such that the vertical position of the magnetic stirring apparatus 1 is also adjustable by a corresponding displacement of the adjustment device 5 in a vertical direction 5f. It is therefore advantageous for the radial position of the float body 1f to be additionally stabilised by the passive radial magnetic bearings formed by the permanent magnets 1m, 5a, 5b.

The section along the line D-D shown in FIG. 18 shows the container wall 3 and the adjustment device 5 arranged outside the container 3 having supports 5e on which the permanent magnets 5a, 5b, 5c,Sd are arranged adjustably in the direction of displacement 5f. A plurality of permanent magnets 1m is arranged inside the hollow space of the float body 1f and extend in the peripheral direction

The agitating device 6 shown in FIG. 19 in a longitudinal section has a magnetic stirring apparatus 1 which has a circular annular shaped agitator 1a which is fixedly connected to a hollow cylinder-shaped float body 1f. Permanent magnets 1m spread in the peripheral direction are arranged inside the float body 1f. The drive device 2 has a cylinder-shaped part 2g which is fixedly connected to the axle 2b. Permanent magnets 2d extending in the peripheral direction are arranged at the end section of the part 2g such that the magnetic stirring apparatus 1 can be set into rotation in the direction of rotation 1e via the interaction occurring between the permanent magnets 2d and 1m. Moreover, the drive device 2 is journalled in a displaceable manner in the direction 2h, whereby the vertical position of the magnetic stirring device 1 can also be influenced. This radial coupling has the advantage that it only exerts a slight destabilising force on the magnetic stirring device 1, with a simultaneously good stabilisation in the radial direction.

FIG. 20 shows the flow body if in cross-section along the sectional line EE, with four permanent magnets 1m spread in the peripheral direction being arranged inside said flow body 1f. The cylinder-shaped part 2g of the drive device 2 is arranged outside the container 3, with four permanent magnets 2d also being arranged spread in the peripheral direction at part 2g such that a magnetic coupling is formed between the permanent magnets 1m of the float body 1f and the permanent magnet 2d of the drive device 2.

The container 3 can, as indicated in FIG. 21, be designed as a closed bioreactor provided with closable openings 3b and with feedlines and drain lines 3c.

The float body 1f could also be fixedly and unreleasably connected to the bar 1b. A set of magnetic stirring apparatuses 1 could also be provided, with the float body if being arranged at a different position on the bar 1b for each magnetic stirring apparatus 1 so that a suitable magnetic stirring apparatus 1 can be selected depending on the liquid level in the container 3.

1. A magnetic stirring apparatus (1) comprising an agitator (1a), at least one permanent magnet (1d, 1e) and a float body (1f, which are connected to one another.

2. A magnetic stirring apparatus (1) comprising a bar 1b), with the agitator (1a) being arranged at the first end section (1o) of the bar (1b) and the float body (1f being arranged at the second end section (1o).

3. A magnetic stirring apparatus (1) in accordance with one of the preceding claims characterised in that it tapers into a tip (1c) in the region of the first end section (1o).

4. A magnetic stirring apparatus (1) in accordance with one of the preceding claims characterised in that the agitator (1a ) is formed symmetrically; and in that at least two permanent magnets (1d, 1e) are symmetrically arranged in the agitator (1a).

5. A magnetic stirring apparatus (1) in accordance with one of the preceding claims characterised in that the float body (1f) has an increasing inner cross-section at least along one part section in the direction of the second end section (1p)

6. A magnetic stirring apparatus (1) in accordance with one of the preceding claims characterised in that at least one vane (1h) is arranged at the bar (1b).

7. A magnetic stirring apparatus (1) in accordance with one of the preceding claims characterised in that a permanent magnet (1m) is arranged in the float body (1f).

8. A magnetic stirring apparatus (1) in accordance with one of the preceding claims characterised in that the float body (1f is formed in an annular shape.

9. A magnetic stirring apparatus (1) in accordance with one of the preceding claims characterised in that the agitator (1a) is made in a bar shape, a star shape or a circular shape.

10. An agitating device (6) comprising a magnetic stirring apparatus (1) having a permanent magnet (1d, 1e) and a float body (1f), in particular a magnetic stirring apparatus (1) in accordance with one of the preceding claims, and comprising a magnetic drive apparatus (2), said drive apparatus (2) and said permanent magnets (1d, 1e) of the magnetic stirring apparatus (1) being mutually matched, arranged and designed such that they form a magnetic coupling.

11. An agitating device (6) in accordance with claim 10 characterised in that the drive apparatus (10) has permanent magnets (2c, 2d) which form a magnetic coupling together with the permanent magnets (1d, 1e) of the magnetic stirring apparatus (1).

12. An agitating device (6) in accordance with claim 10 characterised in that the drive apparatus (10) has a plurality of electromagnetic coils (2f which form an electric motor together with the permanent magnets (1d, 1e) of the magnetic stirring apparatus (1).

13. An agitating device (6) in accordance with claim 11 characterised in that the permanent magnets (1d, 1e) of the magnetic stirring apparatus (1) and the permanent magnets (2c, 2d) of the drive apparatus (2) are arranged and formed such that they mutually form a passive radial and/or axial magnetic bearing.

14. An agitating device (6) in accordance with one of the claims 10 to 13 characterised in that the magnetic stirring apparatus (1) has a toe bearing.

15. A bio-reactor comprising a magnetic stirring apparatus (1) in accordance with one of the claims 1 to 9 and/or comprising an agitating device (6) in accordance with one of the claims 10 to 14.
